(19) United States
(12) Patent Application Publication
(10) Pub. No.: US 2025/0159748 A1
(43) Pub. Date: May 15, 2025

(54) ENHANCED REDUCED CAPABILITY USER EQUIPMENT

(71) Applicant: Apple Inc., Cupertino, CA (US)

(72) Inventors: Hong He, San Jose, CA (US); Dawei Zhang, Saratoga, CA (US); Wei Zeng, Saratoga, CA (US); Haitong Sun, Cupertino, CA (US); Weidong Yang, San Diego, CA (US); Seyed Ali Akbar Fakoorian, San Diego, CA (US); Yushu Zhang, Beijing (CN); Chunxuan Ye, San Diego, CA (US); Jie CUI, San Jose, CA (US); Huaning Niu, San Jose, CA (US)

(21) Appl. No.: 18/837,067

(22) PCT Filed: Feb. 12, 2022
(86) PCT No.: PCT/CN2022/076119

§ 371 Date: Aug. 8, 2024

(51) Int. Cl. H04W 76/20; H04W 8/22; H04W 56/00; H04W 74/0833

(52) U.S. Cl. CPC H04W 76/20; H04W 8/22; H04W 56/0015; H04W 74/0833

(57) ABSTRACT

Disclosed are methods, systems, and computer-readable medium to perform operations including: determining a number of repetitions for a random access response or a paging message using downlink control information; receiving one or more instances of the random access response or the paging message; and decoding at least one of the one or more instances of the random access response or the paging message using the number of repetitions.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

To reduce complexity, reduce power usage, reduce data rate reduce data requirements, or a combination of these, an enhanced reduced capability user equipment can have one or more of the following features. An enhanced reduced capability user equipment can use a different bandwidth mode, e.g., with a maximum of 5 MHz, and can switch between bandwidth modes. An enhanced reduced capability user equipment can use a half-slot for an synchronization signal/physical broadcast channel (“SSB”) block, or a slot-based SSB pattern. An enhanced reduced capability user equipment can use random access response, paging message, or both, repetitions. An enhanced reduced capability user equipment can have a reduced peak data rate, e.g., determined dynamically or using a scaling factor.

In accordance with one aspect of the present disclosure, determining, by a user equipment, a type of a transmission; selecting, based on the type of the transmission, a bandwidth mode from a plurality of bandwidth modes; and communicating, using the bandwidth mode, the transmission.

In accordance with one aspect of the present disclosure, communicating, by a base station and using a first bandwidth mode, a first transmission with a user equipment; determining that a second transmission with the user equipment will use a second bandwidth mode that is a different bandwidth mode than the first bandwidth mode; determining a period of time for a switch from the first bandwidth mode to the second bandwidth mode; waiting the period of time after communicating the first transmission using the first bandwidth mode; and in response to waiting the period of time, transmitting, using the second bandwidth mode, the second transmission.

In accordance with one aspect of the present disclosure, receiving, by a user equipment and in a half-slot, a synchronization signal/physical broadcast channel (“SSB”) block that comprises seven symbols spanning an entire half-slot; and synchronizing, with a base station, using the SSB block in the half-slot.

In accordance with one aspect of the present disclosure, determining a number of repetitions for a random access response or a paging message using downlink control information; receiving one or more instances of the random access response or the paging message; and decoding at least one of the one or more instances of the random access response or the paging message using the number of repetitions.

In accordance with one aspect of the present disclosure, determining a number of repetitions for a random access response or a paging message using a number of repetitions for an associated physical random access channel communication; receiving one or more instances of the random access response or the paging message; and decoding at least one of the one or more instances of the random access response or the paging message using the number of repetitions.

In accordance with one aspect of the present disclosure, determining, for an enhanced-reduced capability user equipment, a maximum data rate scaling factor; and communicating, with the enhanced-reduced capability user equipment, data using the maximum data rate scaling factor.

In accordance with one aspect of the present disclosure, determining, by a base station, whether a device to which the base station will send a random access response or a paging message is an enhanced reduced capability device; in response to determining that the device is an enhanced reduced capability device, determining a scaling factor for the enhanced reduced capability device; and sending, by the base station and to the device and using the scaling factor for the enhanced reduced capability device, the random access response or the paging message.

A system, e.g., a base station, an apparatus comprising one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1 to 57.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, in accordance with some embodiments.

FIGS. 2A-C depict example environments of communications between a user equipment and a base station.

FIG. 3 illustrates a flowchart of an example method, in accordance with some embodiments.

FIGS. 4A-C depict example synchronization signal (“SS”) and physical broadcast channel (“PBCH”) (combined “SSB”) patterns.

FIG. 5 illustrates a flowchart of an example method, in accordance with some embodiments.

FIG. 6 depicts an example random access response (“RAR”) graph.

FIGS. 7-9 illustrates a flowchart of an example method, in accordance with some embodiments.

FIG. 10 illustrates a user equipment (UE), in accordance with some embodiments.

FIG. 11 illustrates an access node, in accordance with some embodiments.

### DETAILED DESCRIPTION

User equipment (“UE”), such as new radio (“NR”) reduced capability (“RedCap”) devices for 3GPP Release 17, can include industrial sensors, video surveillance devices, and wearables, to name a few examples. The user equipment can require low complexity, low power consumption, low data rate requirements, or a combination of these. In some instances, a Release 17 RedCap UE may typically operate using a reduced channel bandwidth of approximately 20 MHz within frequency range 1 (“FR1”), defined as sub-6 GHz frequency bands for NR. The reduced channel bandwidth operation allows for a reduction in cost of a RedCap UE compared to a regular UE.

Newer devices targeting a further reduction in NR RedCap UE complexity, cost, energy consumption and data rates are intended to further expand the market for RedCap use cases. For instance, an NR RedCap device, e.g., an enhanced RedCap (“eRedCap”) device for 3GPP Release 18, can have a maximum supported peak data rate of 10 Mbps, not overlap with existing low-power wide-area (“LPWA”) solutions, or both. As a result, NR eRedCap devices can have a further bandwidth reduction to 5 MHz in frequency range 1 (“FR1”), e.g., be limited to frequencies of 5 MHz or less, a reduced peak data rate in FR1, or both. In some examples, NR eRedCap devices can have a relaxed processing timeline for a physical downlink shared channel (“PDSCH”), a physical uplink shared channel (“PUSCH”), channel state information (“CSI”), or a combination of two or more of these.

To enable an eRedCap device to communicate with other devices, such as a base station, while satisfying the requirements for an eRedCap, the eRedCap can use dual radio-frequency bandwidth modes, e.g., each bandwidth mode for different communications, half-slot synchronization signal/physical broadcast channel (“SSB”) patterns, slot-based enhanced-SSB (“eSSB”) patterns, random access response repetition, paging repetition, a scaling factor to reduce a peak data rate, or a combination of two or more of these.

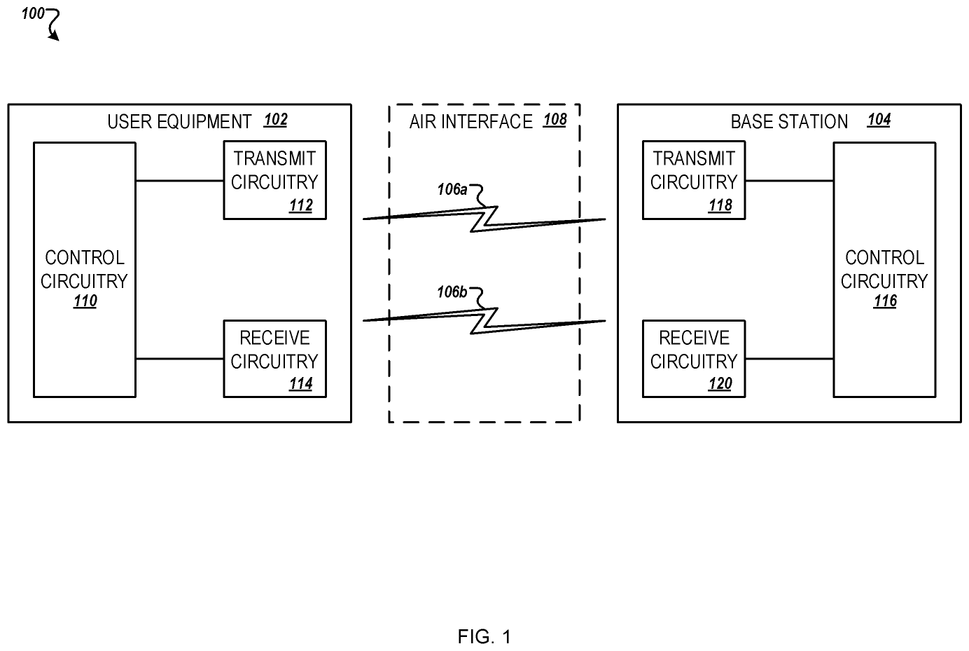

FIG. 1 illustrates a wireless network 100, in accordance with some embodiments. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

For purposes of convenience and without limitation, the wireless network 100 is described in the context of Long Term Evolution (LTE) and Fifth Generation (5G) New Radio (NR) communication standards as defined by the Third Generation Partnership Project (3GPP) technical specifications. More specifically, the wireless network 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 100 may also be a Standalone (SA) network that incorporates only NR. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, printers, machine-type devices such as smart meters or specialized devices for healthcare monitoring, remote security surveillance systems, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some embodiments, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may be adapted to perform operations associated with selection of codecs for communication and to adaption of codecs for wireless communications as part of system congestion control. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry, including communications using codecs as described herein.

The control circuitry 110 can perform various operations described in this specification. For instance, the control circuitry 110 can determine a type of a transmission for the UE 102, whether the UE transmits or receives the transmission. The control circuitry 110 can select a bandwidth mode based on the type of transmission. The control circuitry 110 can use the transmit circuitry 112 to synchronize with the base station 104. The control circuitry 110 can determine a number of repetitions for a random access response, a paging message, or both.

The transmit circuitry 112 can perform various operations described in this specification. For instance, the transmit circuitry 112 can send a transmission to a base station, another UE, or both. The transmission can include a random access message.

The receive circuitry 114 can perform various operations described in this specification. For example, the receive circuitry 114 can receive a transmission from a base station or another UE. The transmission can include a synchronization signal block, a control resource set, a synchronization signal/physical broadcast channel (“SSB”) block, a physical broadcast channel (“PBCH”), a random access response, or a paging message.

In various embodiments, aspects of the transmit circuitry 112, receive circuitry 114, and control circuitry 110 may be integrated in various ways to implement the circuitry described herein. The control circuitry 110 may be adapted or configured to perform various operations such as those described elsewhere in this disclosure related to a UE. The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108. Similarly, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In embodiments, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which comprises a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108.

The control circuitry 116 may be adapted to perform operations for analyzing and selecting codecs, managing congestion control and bandwidth limitation communications from a base station, determining whether a base station is codec aware, and communicating with a codec-aware base station to manage codec selection for various communication operations described herein. The transmit circuitry 118 and receive circuitry 120 may be adapted to transmit and receive data, respectively, to any UE connected to the base station 104 using data generated with various codecs described herein. The transmit circuitry 118 may transmit downlink physical channels comprised of a plurality of downlink subframes. The receive circuitry 120 may receive a plurality of uplink physical channels from various UEs, including the UE 102.

In this example, the one or more channels 106A, 106B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 102 may directly exchange communication data with other UEs via a ProSe interface. The ProSe interface may alternatively be referred to as a SL interface and may comprise one or more logical channels, including but not limited to a PSCCH, a PSSCH, a PSDCH, and a PSBCH.

To support the reduced bandwidth and peak data rate requirements of eRedCap UEs, several issues may need to be addressed, such as, for example, discrepancies in the required bandwidth required for various initial access procedures versus the reduced 5 MHz frequency bandwidth within which eRedCap UEs may be required to operate. Table 1, below, indicates the maximum transmission bandwidth configuration for the available subcarrier spacing (“SCS”) frequencies for 5 MHz transmissions. As shown in Table 1, for 5 MHz transmissions in FR1, a base station, a user equipment, or both, can use either 15 kHz or 30 kHz SCS, e.g., during transmissions between the base station and the user equipment. At 15 kHz SCS, a UE may communicate with up to 25 resource blocks while operating in 5 MHz frequency, while at 30 kHz SCS, a UE may communicate with up to 11 resource blocks while operating in 5 MHz frequency.

TABLE 1
Maximum transmission bandwidth configuration

| | 5 MHz |
|---|---|
| Subcarrier Spacing (kHz) | N_{RB} |
| 15 | 25 |
| 30 | 11 |

In contrast, table 2, below, shows the required bandwidth for channels of initial access procedure. In particular, Table 2 summarizes the required bandwidth (“BW”) for synchronization signal block (“SSB”); control resource set 0 (“CORESET #0”), e.g., that transmits physical downlink control channel (“PDCCH”) for system information block 1 (“SIB1”) scheduling; and physical random access channel (“PRACH”) with 15 kHz and 30 kHz SCS for initial access procedure. The initial access procedure can include cell search and system information acquisition.

TABLE 2
Required bandwidth for channels of Initial Access Procedure

| | Synchronization | | Physical Random |
|---|---|---|---|
| | Signal Block | CORESET#0 | Access Channel |
| 15 kHz SCS | 3.6 MHz | 24 RBs @ 4.32 MHz | L839: 6RB @ 15 kHz SCS |
| | | 48 RBs @ 8.64 MHz | L139: 12RB @ 2.16 MHz |
| | | 96 RBs @ 17.28 MHz | |
| 30 kHz SCS | 7.2 MHz | 24 RBs @ 8.64 MHz | L839: 3RB @ 30 kHz SCS |
| | | 48 RBs @ 17.28 MHz | L139: 12RB @ 4.32 MHz |

As indicated in Table 2, there are two potential problems with these frequencies for use with eRedCap devices, e.g., when a base station communicates with an eRedCap device. Specifically, for SSB reception, a minimum 7.2 MHz bandwidth is desirable to support 30 kHz SCS SSB, which 7.2 MHz minimum bandwidth is greater than the 5 MHz target of eRedCap UEs. Accordingly, while an eRedCap UE may be able to support SSB reception at 15 kHz SCS due to the SSB bandwidth of 3.6 MHz, the eRedCap UE may have difficulty supporting SSB reception at 30 kHz SCS due to the SSB bandwidth of 7.2 MHz.

For CORESET #0 for FR1, an eRedCap device that is limited to 5 MHz bandwidth (translating to 11 PRBs at 30 kHz or 25 PRBs at 15 kHz) may be unable to support all possible CORESET #0 configurations. For example, CORESET #0 for Type0-PDCCH can be configured as large as 17.28 MHz in the frequency domain, e.g., for 96 PRBs for 15 kHz SCS and 48 PRBs for 30 kHz SCS, and up to 3 orthogonal frequency division multiplexing (“OFDM”) symbols. In reference to Table 2, an eRedCap UE may only be able to support a CORESET #0 configuration of 24 PRBs at 4.32 MHz in 15 kHz SCS operation while being unable to support other CORESET #0 configurations of 48 PRBs at 8.64 MHz or 96 PRBs at 17.28 MHz in 15 kHz SCS operation due to the eRedCap UE's potential limitation of 5 MHz bandwidth. As seen in Table 2, an eRedCap device might not have any CORESET #0 configurations with 30 kHz SCS that can be used because the two options exceed the eRedCap UE's potential maximum 5 MHz bandwidth, which is restricted to a maximum of 11 PRBs at 30 kHz SCS.

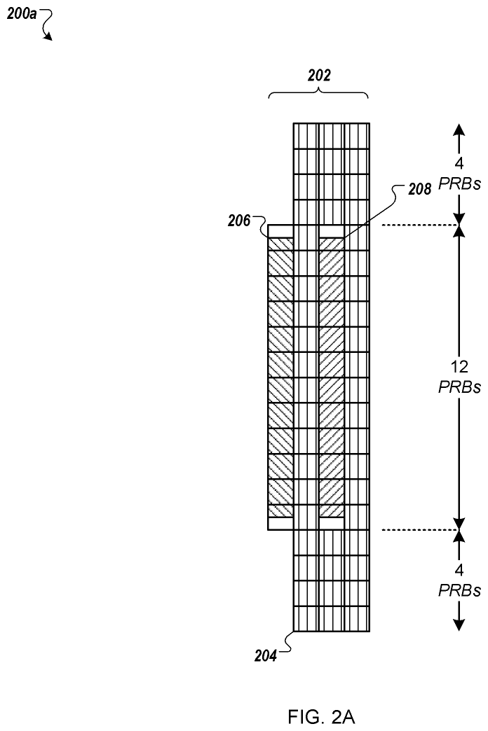

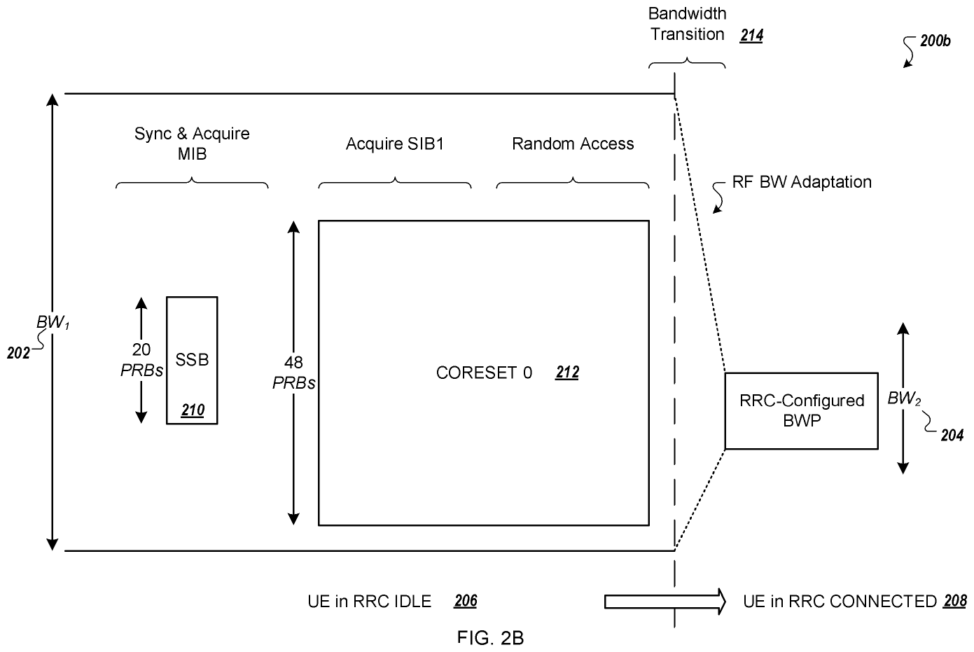

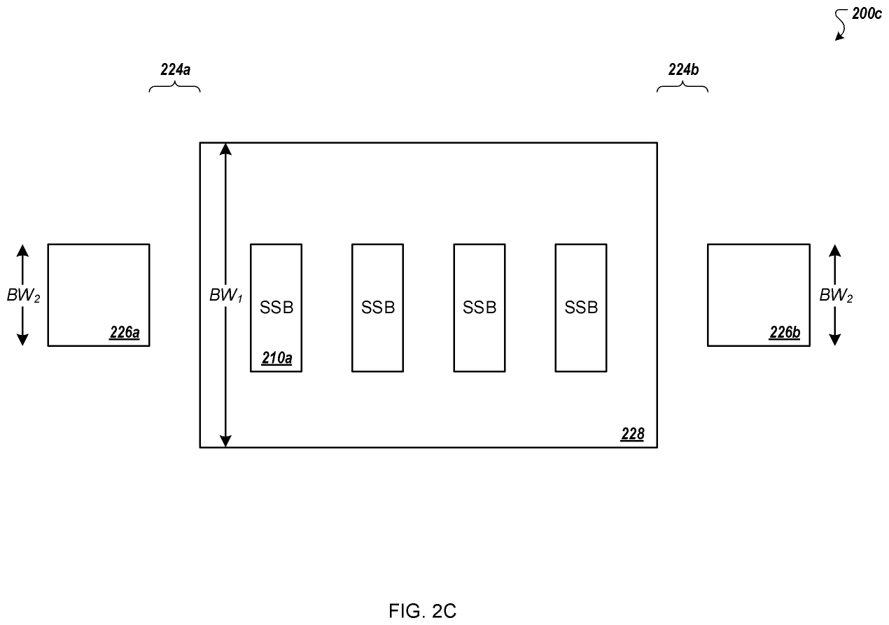

FIG. 2A depicts an example environment 200a that includes a legacy synchronization signal (“SS”) and physical broadcast channel (“PBCH”) (combined “SSB”) pattern 202. The legacy SSB pattern 200a includes a physical broadcast channel (“PBCH”) 204, a primary synchronization signal (“PSS”) block 206, and a secondary synchronization signal (“SSS”) block 208.

As shown in the legacy SSB pattern 202, the SSB pattern spans more than 12 PRBs but an eRedCap UE might be limited to 11 PRBs for 30 kHz SCS. Specifically, the PBCH 204 includes 20 PRBs in a frequency domain, the PSS 206 includes 11 PRBs in the frequency domain, and the SSS block 208 includes 11 PRBs in the frequency domain. As a result, an eRedCap UE would be unable to receive the entire PBCH 202 that includes 20 PRBs in the frequency domain when using a 30 kHz SCS that has 11 PRBs in the frequency domain.

FIG. 2 depicts an example environment 200b in which a user equipment supports two different maximum radio frequency bandwidths. The user equipment can use the two different maximum radio frequency bandwidths for different types of transmissions with a base station. For instance, the user equipment can use a legacy frequency bandwidth, e.g., greater than 5 MHz, for communications that include more than 11 PRBs in the frequency domain and a smaller frequency bandwidth for communications that include 11 or fewer PRBs. As described above, this can provide cost savings benefits, improve battery life, or both, compared to other user equipment.

In some implementations, to enable a user equipment to have reduced complexity, power usage, a maximum data rate, e.g., during particular time periods, or a combination of these, the user equipment can support two different maximum radio frequency bandwidths, a first bandwidth BW₁ 210 and second bandwidth BW₂ 212. The two bandwidths can represent different bandwidth modes in which a device can use a subset of the bandwidth identified by the mode for data transmissions with another device. The first bandwidth BW₁ 210 is greater than the second bandwidth BW₂ 212. The second bandwidth BW₂ 212 can have a predetermined maximum frequency, e.g., 5 MHz.

The base station, the user equipment, or both, can determine which of the bandwidths to use based on a transmission type for a data transmission with the other device. Some example transmission types include transmissions while the user equipment is in a radio resource control (“RRC) IDLE state 214; an SSB-based radio resource management (“RRM”) measurement, e.g., for cell re-selection mobility, whether the user equipment is in an RRC_IDLE state or RRC_CONNECTED state; and any other transmission type.

For instance, when the user equipment is in an RRC_IDLE state 214, e.g., performing a cell search procedure including initial access, the base station or the user equipment can determine to use the first bandwidth BW₁ 210. When the base station or the user equipment is performing an SSB-based radio resource management (“RRM”) measurement, e.g., for cell re-selection mobility, whether in an RRC_IDLE or an RRC_CONNECTED state, the base station or the user equipment can determine to use the first bandwidth BW₁ 210.

When the base station or the user equipment determines that it will perform any other type of transmission, the device can determine to use the second bandwidth BW₂ 212. For example, after initial access, e.g., after RRC Setup, RRC Resume, or RRC Reestablishment, an RRC_CONNECTED 216 user equipment can use, e.g., be configured with, UE-dedicated bandwidth parts (“BWPs”) that have a smaller bandwidth than the second bandwidth BW₂ 212 maximum when the user equipment is not performing an SSB-based RRM measurement.

By reducing the bandwidth frequency used by the user equipment, the user equipment can reduce, e.g., minimize, power consumption.

The base station or the user equipment can determine the first bandwidth BW₁ 210, the second bandwidth BW₂ 212, or both, using any appropriate process. For instance, the first bandwidth BW₁ 210 can be hard-encoded, e.g., in the 3GPP specification. In an example, the first bandwidth BW₁ 210 can cover at least the SSB bandwidth 7.2 MHz for 30 kHz SCS.

Alternatively or additionally, in some implementations, the base station or the user equipment can determine a first bandwidth BW₁ 210 that supports at least one CORESET configuration to enable aggregation level 16, e.g., (N_{RB}^{CORESET}, N_{symb}^{CORESET})=(48,2)) for common search space (“CSS”) sets with 30 kHz SCS.

The base station or the user equipment can use any appropriate bandwidth for the first bandwidth BW₁ 210 that is greater than the second bandwidth BW₂ 212 and that, in some instances, allows the user equipment to perform certain operations that require greater bandwidth than provided by the second bandwidth BW₂ 212, such as initial access operations (e.g., SSB or CORESET #0 reception), for example. For instance, when the second bandwidth BW₂ 212 is 5 MHz, the first bandwidth BW₂ 210 can be 10 MHz or 20 MHz.

In some implementations, the base station, the user equipment, or both, can determine a value of the first bandwidth BW₁ 210 using numerologies. The numerologies can define the frequency domain subcarrier spacings.

As shown in FIG. 2, the user equipment, e.g., a Rel-18 eRedCap UE with dual-RF-Bandwidth, can select between the first bandwidth BW₁ 210 and the second bandwidth BW₂ 212 for different transmissions. The user equipment can, when in an RRC_IDLE state, use the wider radio frequency first bandwidth BW₁ 210 for a cell search procedure including initial access and random access. This can enable the user equipment to receive the entire SSB signals 218, a CORESET #0 220, e.g., including a system information block 1 (“SIB1”), one or more random access messages, e.g., Msg2, Msg4, or both, in random access.

The SSB signal 218 can occupy twenty physical resource blocks (“PRBs”), e.g., according to the legacy SSB pattern 202. In the illustrated example, the CORESET #0 220 occupies 48 PRBs, although CORESET #0 220 may be configured with greater or fewer PRBs depending on the situation (see Table 2). Both twenty PRBs and 48 PRBs can be greater than the number of PRBs available when a device uses the second bandwidth mode BW₂ 212 for communications. Accordingly, by using the first bandwidth mode BW₁ 210 for reception of the SSB 218 and/or the CORESET #0 220, the device may successfully communicate initial access transmissions, such as SSB and/or CORESET #0 reception, that may require the greater bandwidth provided by BW₁ 210.

After moving from RRC_IDLE to RRC_CONNECTED state, the user equipment can be configured, e.g., can configure itself or be configured by the base station, to use a bandwidth that satisfies the second bandwidth BW₂ 212. The bandwidth that satisfies the second bandwidth BW₂ 212 can be equal to or smaller than the second bandwidth BW₂ 212. Accordingly, the use of smaller bandwidth in accordance with BW₂ 212 allows the UE to minimize power consumption, among other benefits.

In some implementations, there can be a gap for a transition process 222 between the two bandwidths 210-212. For instance, there can be a gap between data transmissions using the first bandwidth BW₁ 210 and the second bandwidth BW₂ 212, whether the going from the first bandwidth BW₁ 210 to the second bandwidth BW₂ 212 or the second bandwidth BW₂ 212 to the first bandwidth BW₁ 210. The gap can be hard-encoded, e.g., on the device based on specification, or communicated or derived using other features. In some examples, the user equipment can report the gap as part of a UE capability report. The user equipment, the base station, or both, can determine to skip transmitting, e.g., sending or receiving, data during the gap for the transition process 222.

FIG. 2C depicts an example environment 200c with a transmission gap 224. In the environment 200c, the gap 224 is for an RRM measurement that includes multiple SSBs 210a-d. The gap 224a-b can be used in other appropriate situations between transmissions from a first type 226a-b and a second type 228, such as a transition from initial access transmissions to RRC CONNECTED transmissions as described above.

In the environment 200c, the eRedCap UE is communicating a first transmission 226a with the base station using the second bandwidth BW₂. The first transmission 226a can be any appropriate type of transmission, such as transmitting uplink data or receiving downlink data or a combination of both. When the base station determines that the user equipment needs to perform a transmission using the first bandwidth BW₁, the base station determines a duration of the first gap 224a, e.g., using hardcoded data or data from a UE capability report. The base station then waits for the duration of the gap 224a to expire before communicating a second transmission 228, e.g., the RRM measurement, using the first bandwidth BW₁. The second transmission 228 can be during an SSB measurement timing configuration window.

Once the base station is done communicating with the eRedCap UE, the base station can wait a duration of time defined by a second gap 224b before communicating a third transmission 226b with the eRedCap UE using the second bandwidth BW₂. The duration of the second gap 224b can be the same as the duration of the first gap 224a or a different duration than the duration of the first gap 224a.

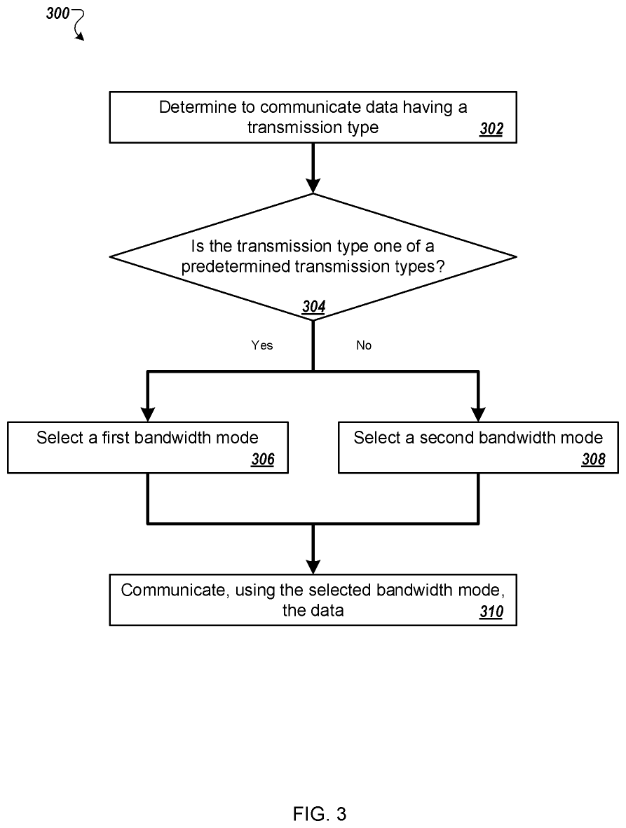

FIG. 3 illustrates a flowchart of an example method 300, according to some implementations. For clarity of presentation, the description that follows generally describes method 300 in the context of the other figures in this description. For example, method 300 can be performed by the user equipment or the base station described throughout this specification, such as user equipment 102 or base station 104 in FIG. 1, e.g., with reference to FIG. 2. It will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

A device determines to communicate data having a transmission type (302). The transmission type can be any appropriate transmission type, such as those discussed above with reference to FIG. 2.

The device determines whether the transmission type is one of a predetermined transmission types (304). The predetermined transmission types can be those for which communications with a user equipment should use a first bandwidth mode. In some examples, the predetermined transmission types can be those for which communications with a user equipment should use a second bandwidth mode.

The device selects a first bandwidth mode (306). For instance, in response to determining that the transmission type is one of the predetermined transmission types, the device selects the first bandwidth mode.

The device selects a second bandwidth mode (308). For example, in response to determining that the transmission type is not one of the predetermined transmission types, the device selects the second bandwidth mode.

The device communicates, using the selected bandwidth mode, the data (310). For instance, the device uses either the first or the second bandwidth mode depending on which bandwidth mode was selected.

In some implementations, the method 300 can include additional steps, fewer steps, or some of the steps can be divided into multiple steps. For example, the device can perform step 302, optionally step 304, step 306, and step 310. In some examples, the device can perform step 302, optionally step 304, step 308, and step 310. The device can perform one or more steps described with reference to FIG. 2 or the examples below.

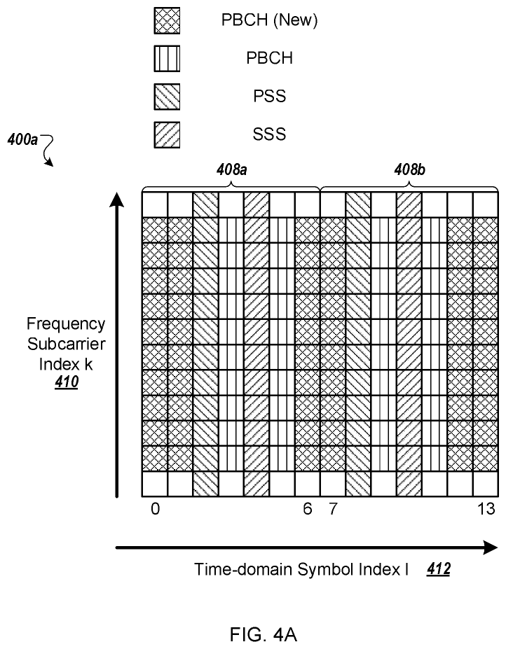

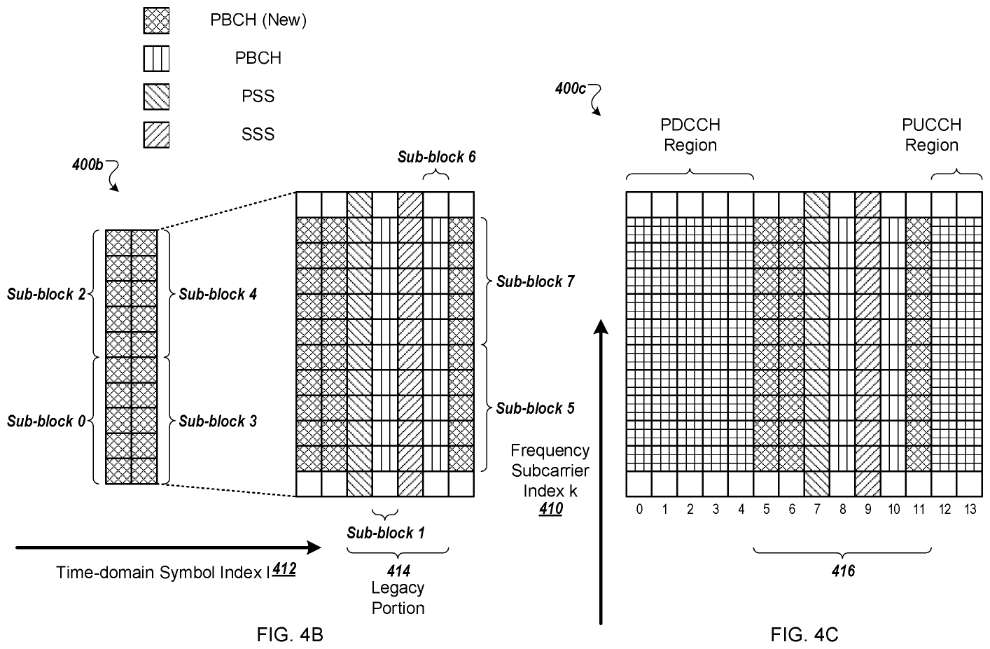

FIGS. 4A-D depict example synchronization signal (“SS”) and physical broadcast channel (“PBCH”) (combined “SSB”) patterns 400a-d. A user equipment, a base station, or both, can use an SSB pattern to map PBCH to resource elements for user equipment, e.g., eRedCap, use, e.g., during a random access procedure.

For instance, a random access procedure can include preamble transmission on a physical random access channel (“PRACH”), Message 3 transmission on a physical uplink shared channel (“PUSCH”), Message 2/4 transmissions on a physical downlink shared channel (“PDSCH”), and corresponding signaling, e.g. grants or hybrid automatic repeat request acknowledgement (“HARQ-ACK”).

As described above, an eRedCap UE may operate with a wider bandwidth (e.g., 10 or 20 MHz) for handling operations that require greater bandwidth, such as initial access procedures, and then switch to a narrower bandwidth (e.g., 5 MHz) for other operations, such as connected mode operations, to achieve power saving benefits for eRedCap devices. This solution may still require the eRedCap UE to be equipped with the capability to operate within the wider bandwidth, which may limit the cost saving benefits of the eRedCap UE.

In certain instances, however, to achieve greater cost savings, an eRedCap UE may not be equipped to handle or may be restricted from handling communications with frequency bandwidth greater than 5 MHz. In view of some restricted bandwidth requirements of eRedCap UEs, an updated SSB pattern can be used to allow an eRedCap UE to accurately receive SSB blocks while still operating within a smaller bandwidth. FIG. 4A depicts example half-slot-based extended SSB 400a (“eSSB”) patterns that an eRedCap UE operating within a 5 MHz bandwidth can successfully monitor. For instance, the patterns 400a include a first half-slot-based eSSB pattern 408a and a second half-slot-based eSSB pattern 408b, allowing for each slot to accommodate two eSSBs if needed.

In the time domain, the eSSB patterns 408a-b for a user equipment, e.g., an eRedCap, consist of seven symbols spanning an entire half-slot. The symbols can be numbered in increasing order from 0 to 6 within the eSSB block.

In the frequency domain, the PBCH includes multiple physical resource blocks (PRBs). As seen in FIG. 4B, the eSSB pattern 408 occupies a reduced number of PRBs in the frequency domain compared to legacy (i.e., Release 15/16) SSB patterns (e.g., a reduction from 20 PRBs to 12 PRBs). With this design, an eRedCap UE can maintain operation within 5 MHz bandwidth and still accurately receive the eSSB without needing to switch to wider bandwidth operation. Further, the available resource blocks for PBCH in eSSB transmission is kept at 10*5=50 physical resource blocks. Because 50 physical resource blocks is the number required for SSBs in 3GPP Rel-15/16, using the eSSB pattern 408 can achieve the same cell coverage as legacy SSBs from an SSB perspective.

While the PSS and SSS of the eSSB pattern remain in a relative position similar to their respective positions in a legacy SSB, at least a portion of the PBCH of the eSSB may be mapped to different positions compared to legacy SSB. Accordingly, to use a half-slot-based eSSB pattern 400a, different mapping schemes for PBCH within an eSSB Block are proposed. FIGS. 4A-B depict different examples of such mappings.

In FIG. 4A, the mapping can indicate that the resource elements are mapped in increasing order of first the frequency subcarrier index k 410 and then the time-domain symbol index 1 412. For example, the resource elements of PBCH for an eSSB may first be mapped to symbol 0, beginning with a lowest frequency subcarrier index k and continuing with consecutive resource elements for a span of 10 PRBs, and then proceeding to symbol 1 to repeat the mapping. In this example, the PBCH is mapped in this way sequentially on symbols 0, 1, 3, 5, and 6 of eSSB 408a. This PBCH mapping scheme, however, results in a completely different PBCH mapping compared to PBCH in a legacy SSB. For example, in a legacy SSB, PBCH would still occupy the relative same position as that of PBCH in symbols 3 and 5 of the depicted eSSB 408a. By using a PBCH mapping scheme of increasing order of first the frequency subcarrier index k 410 and then the time-domain symbol index l 412, the PBCH resource elements in symbols 3 and 5 of eSSB 408a may be written with different PBCH information compared to a legacy SSB, so that the eSSB would not be able to share the overlapped PBCH resource elements in symbols 3 and 5 with legacy SSB. In other words, a legacy UE would not be able to read the eSSB 408 without further modification of its logic for processing SSBs.

FIG. 4B depicts another example of a PBCH mapping scheme for eSSB 400b. In this example sub-block eSSB pattern 400b, the resource elements are divided into eight sub-blocks. The mapping of these eight sub-blocks is then propagated in such a way as to ensure that the information contained in the legacy positions of the PBCH remain the same as in the legacy SSB so that those shared resource elements can be shared between legacy UEs and eRedCap UEs. This design enables a device using the sub-block eSSB pattern 400b to use a legacy portion 404 with the same PBCH to resource element mapping as in legacy implementations, e.g., pre Rel-18, for the overlapping RBs. In some examples, using the sub-block eSSB pattern 400b can avoid duplicate transmission, minimize signaling overhead, or both, because of the reuse of the same mapping as legacy systems for the relevant portion of the pattern, e.g., the legacy portion 414. In some instances, using this mapping scheme, the eSSB pattern 400b may be overlayed over a legacy SSB pattern 202 since overlapping resource elements contain the same information and can be used by either legacy or eRedCap UEs.

Table 3, below, indicates the partitioning for the sub-block eSSB pattern 400b. In Table 3, an OFDM symbol number within a half slot, e.g., the location of the sub-block resource across time, is indicated for each of the sub-block resources in the sub-block eSSB pattern 400b. Further, in Table 3, the resource block number of the sub-block, relative to the start of the eSSB, across frequency is indicated.

TABLE 3
sub-block eSSB pattern

| | | Resource Bock number |
|---|---|---|
| Sub-Block | OFDM Symbol Number | relative to the |
| Resources | within a half slot | start of an eSSB |
| 0 | 0 | 1-5 |
| 1 | 3 | 1-10 |
| 2 | 0 | 6-10 |
| 3 | 1 | 1-5 |
| 4 | 1 | 6-10 |
| 5 | 6 | 1-5 |
| 6 | 5 | 1-10 |
| 7 | 6 | 6-10 |

In some implementations, resource block 5 in sub-block 3, resource block 6 in sub-block 4, or both, might not be used for PBCH mapping. This can be done to ensure the symbols in sub-block 6 have the same mapping as in legacy system.

In some implementations, the mapping to resource elements can be in increasing order of first the sub-block index, and then frequency subcarrier index k 410 and then the time-domain symbol index 1 412.

The half-slot eSSB solutions illustrated in FIGS. 4A and 4B may allow for transmission of two eSSB within a same slot, but with no symbols reserved for downlink (“DL”) and uplink (“UL”) control signaling in the slot, throughput and HARQ feedback latency may be affected. FIG. 4C depicts an example of a slot-based time-domain eSSB pattern 400d that further includes symbols for control signaling. A device can use the slot-based time-domain eSSB pattern 400c to reserve downlink, uplink, or both, control signals for transmission. By reserving space for control signals, a device can improve throughput, uplink HARQ-ACK feedback latency, or both.

The slot-based time-domain eSSB pattern 400c can have multiple symbols reserved for downlink control, uplink control, or both. For instance, the slot-based time-domain eSSB pattern 400c can have X symbols reserved for downlink control at the beginning of the slot of 14 symbols. In some examples, X=5, e.g., where the value is technically selected, in view of the reduced number of PRBs in the frequency domain for eRedCap operation compared to legacy operation, to support AL=8 in a single slot where AL stands for Aggregation Level (“AL”) for PDCCH transmission.

In some examples, Y symbols are preserved for uplink control, a guard period, or both. For instance, the uplink control symbols can be at the end of the slot of 14 symbols. The guard period can be at the end of the slot of 14 symbols. In some implementations, Y=2, e.g., to support short PUCCH format.

In some implementations, the slot-based time-domain eSSB pattern 400c includes seven symbols 416 in the middle of slot. The seven symbols 416 can be from the symbol index 5 to symbol index 11 assuming the symbol of slot is indexed from index 0. While FIG. 4D depicts one example of a slot-based eSSB pattern for eRedCap UEs, other configurations of control signaling (PDCCH and PUCCH) and the eSSB are within the scope of the present disclosure.

In some instances, the mapping to resource elements for this solution can be in increasing order of first the frequency subcarrier index k and then the time-domain symbol index 1, e.g., since the proposed eSSB pattern here crosses slot boundaries and would unlikely overlap with legacy SSB.

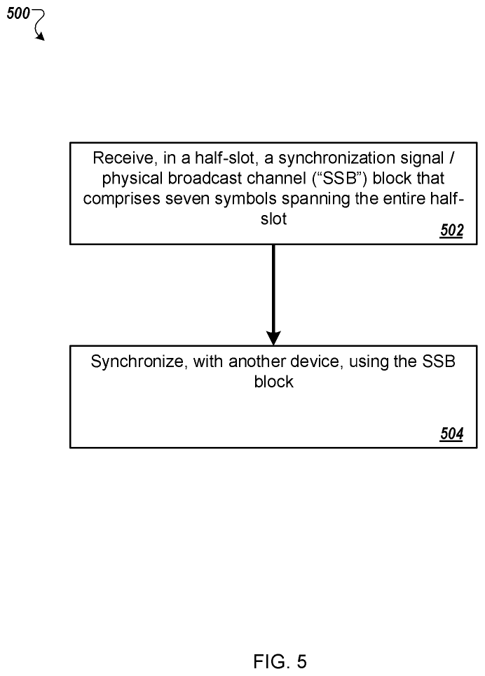

FIG. 5 illustrates a flowchart of an example method 500, according to some implementations. For clarity of presentation, the description that follows generally describes method 500 in the context of the other figures in this description. For example, method 500 can be performed by the user equipment or the base station described throughout this specification, such as user equipment 102 in FIG. 1, e.g., with reference to FIG. 4AC. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

A device receives, in a half-slot, a synchronization signal/physical broadcast channel (“SSB”) block that comprises seven symbols spanning the entire half-slot (502). The device can be a user equipment receiving the SSB block.

The device synchronizes, with another device, using the SSB block (504). For instance, when the device is a user equipment, the other device is a base station.

In some implementations, the method 500 can include additional steps, fewer steps, or some of the steps can be divided into multiple steps. For example, the method 500 can include any steps or other features described above with reference to FIGS. 4A-D. For instance, the SSB block can be in any of the eSSB patterns described with reference to FIGS. 4A-D.

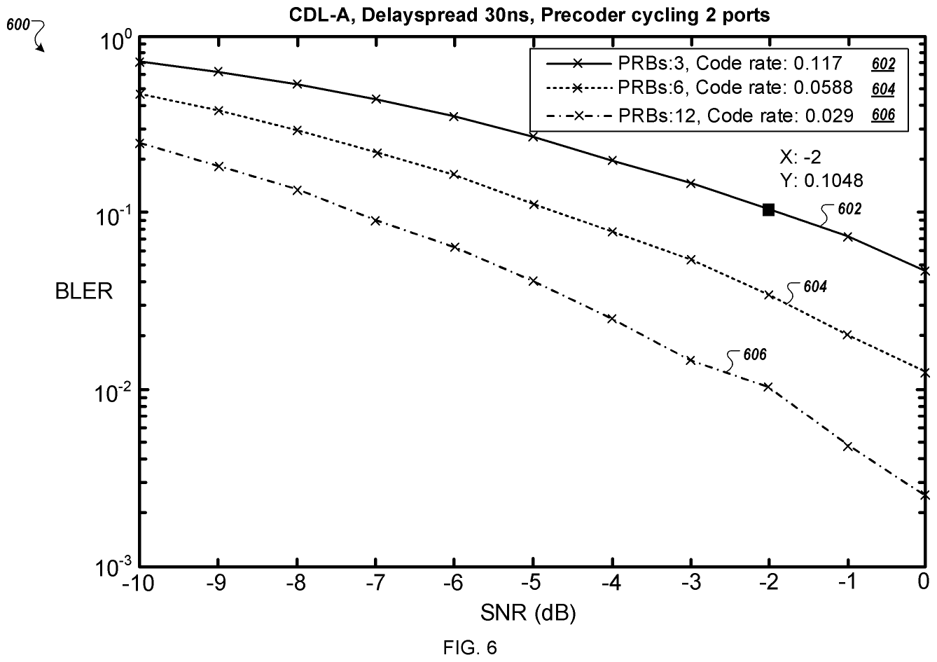

FIG. 6 depicts an example random access response (“RAR”) graph 600. In some situations, reducing bandwidth to a maximum 5 MHz and supporting 30 kHz SCS can reduce performance, e.g., coverage for RARs, paging, or both, for eRedCap devices. For instance, when the minimum payload size of RAR/msg2 is nine bytes, e.g., as defined by 3GPP TS 38.321, consisting of medium access control (“MAC”) subheader for RAR, e.g., two bytes, and MAC payload for RAR, e.g., seven bytes. Assuming the lowest modulation and coding scheme (“MCS”) index is used for a random access communication, e.g., MCSO with QPSK and coding rate of 120/1024, three PRBs should be scheduled for a physical downlink shared channel (“PDSCH”) carrying RAR with minimum payload size of nine bytes. However, as shown by the graph 600, the {3 PRB, 0.117 code rate} curve 602 shows the performance of RAR with MCSO coding rate can reach only 1.9 dB@10% BLER even if precoder cycling transmission (“TX”) diversity with two antenna ports is used.

To address this problem, a device can use a scaling factor with values of {1,1/2,1/4} for PDSCH used for Paging and RAR transmission. This can enable a network, e.g., a base station, to allocate more PRBs than the three PRBs required for a RAR, such as 6 PRBs or 12 PRBs for 9 bytes RAR payload, such that the coverage can be guaranteed. But, eRedCap devices with a maximum bandwidth of 5 MHz that consists of 11 PRBs with 30 kHz SCS, cannot use the scaling value of ¼ for RAR payload because of the required 12 PRBs. Further, the number of reception (“Rx”) branches is reduced from 2 to 1 for eRedCap UEs.

To address this, a device can use a new scaling factor value, e.g., for eRedCap transmissions, to reduce the transport block size for the transmissions, and the number of PRBs required for those transmissions, e.g., to 11 or fewer PRBs as required by an eRedCap UE using 30 kHz SCS. The device can use the new scaling factor to communicate RAR, Paging, or both, messages with an eRedCap device. In some instances, the new scaling factor α can be α=⅛. Table 4, below, provides an example of the new scaling factor α. In some instances, the new scaling factor can be an additional entry in an existing scaling field that is conveyed to the UE.

TABLE 4
scaling factor values

| TB Scaling Field | Scaling factor value |
|---|---|
| ‘00’ | 1 |
| ‘01’ | 0.5 |
| ‘10’ | 0.25 |
| ‘11’ | 0.125 |

In some implementations, a device can support a repetition transmission/reception for RAR, Paging, or both, transmissions to improve coverage level of the RAR or paging message. A device can, e.g., implicitly, determine the repetition number N_RAR using a repetition number of the associated physical random access channel (“PRACH”) selected by a device, e.g., an eRedCap UE, during PRACH procedure. For instance, the repetition number N_RAR can be equal to the repetition level of the device's most recent PRACH.

In some implementations, the repetition number can be explicitly signaled. The repetition number can be hard-encoded in specification e.g., {1, 2, 4, 8}. A device can use one or more bits, e.g., from a scheduling downlink control information (“DCI”) Format 1_0, to determine the repetition number N_RAR.

For instance, the repetition number N_RAR can be indicated by repurposing two reserved bits in the scheduling DCI Format 1_0 to indicate the repetition number (e.g., 1, 2, 4, or 8). Alternatively or additionally, the repetition number N_RAR can be signaled by selection of scrambling sequence [w_0, _1, . . . , w_23] to scramble the CRC bits of scheduling DCI Format 1_0. Table 5, below, shows an example of a mapping of the repetition number N_RAR to a scrambling bit sequence.

TABLE 5
Repetition Number Mapping to Scrambling Bit Sequence

| Repetition Number Value | Scrambling Bit Sequence |
|---|---|
| 1 | <0, 0, 0, 0, . . . , 0, 0> |
| 2 | <0, 1, 0, 1, . . . , 0, 1> |
| 3 | <1, 0, 1, 0, . . . , 1, 0> |
| 4 | <1, 1, 1, 1, . . . , 1, 1> |

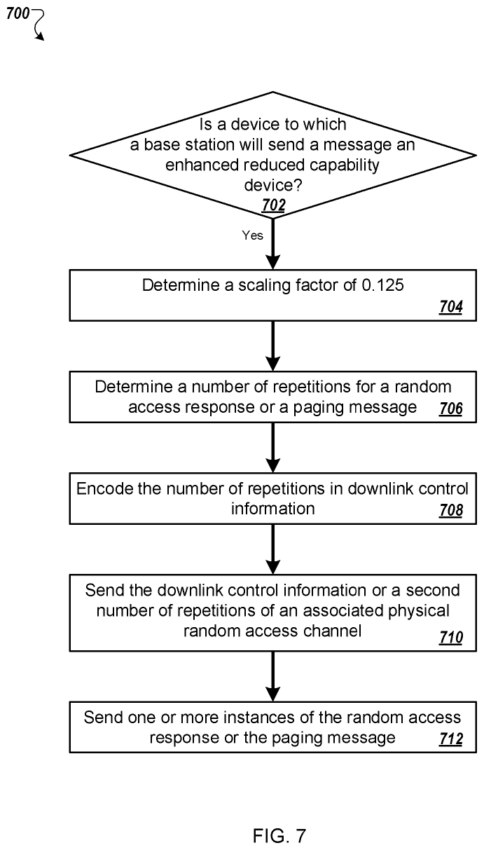

FIG. 7 illustrates a flowchart of an example method 700, according to some implementations. For clarity of presentation, the description that follows generally describes method 700 in the context of the other figures in this description. For example, method 700 can be performed by a base station 104 of FIG. 1. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

A base station can determine whether a device to which the base station will send a message an enhanced reduced capability device (702). For instance, the base station can determine whether the device is a non-reduced capability device or a reduced capability device. The base station can determine whether the device is a reduced capability device or an enhanced reduced capability device. An enhanced reduced capability device can have a maximum bandwidth of 5 MHz.

The base station determines a scaling factor of 0.125 (704). For example, in response to determining that the device is an enhanced reduced capability device, the base station can determine a scaling factor of 0.125.

The base station determines a number of repetitions for a random access response or a paging message (706). For instance, in response to determining that the device is an enhanced reduced capability device, the base station can determine the number of repetitions.

The base station can perform either step 704 or step 706, or both steps 704 and 706.

When the base station determines the number of repetitions, the base station can encode the number of repetitions in downlink control information (708). For instance, the base station can determine one or two bits in the DCI into which the base station should encode the number of repetitions.

In some examples, the base station can select a scrambling bit sequence that indicates the number of repetitions. The base station can encode the scrambling bit sequence in the DCI.

The base station sends the downlink control information or a second number of repetitions of an associated physical random access channel (710). For example, the base station can send the DCI to the enhanced reduced capability device.

In some implementations, instead of encoding the number of repetitions in the DCI, the base station can use a second number of repetitions for the associated PRACH as the number of repetitions for the RAR or paging message. In these implementations, the base station can send the second number of repetitions of the associated PRACH to the eRedCap.

The base station sends one or more instances of the random access response or the paging message (712). A number of the one or more instances can be the number of repetitions. The number of the one or more instances is less than or equal to the number of repetitions.

The order of steps in the method 700 described above is illustrative only, and the method 700 can be performed in different orders. For example, the base station can determine the number of repetitions and then the scaling factor.

In some implementations, the method 700 can include additional steps, fewer steps, or some of the steps can be divided into multiple steps. For example, the base station can perform steps 702, 704, and send a DCI using the scaling factor, without performing the other steps in the method 700. The base station can perform steps 702, 706, 710, and 712, e.g., using the second number of repetitions. The base station can perform steps 702, 706, 708, 710, and 712, e.g., using the DCI. The method 700 can be performed using any steps, data, or both, described with reference to FIG. 6.

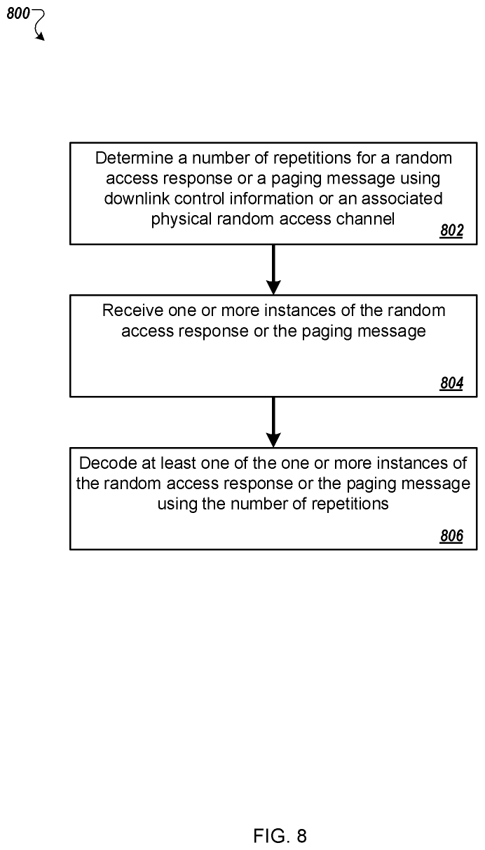

In some implementations, a user equipment, e.g., the user equipment 102 of FIG. 1, can perform operations that correspond to the steps in the method 700, e.g., as described with reference to FIG. 8. For instance, instead of sending the downlink control or the second number of repetitions, the user equipment can receive such data.

FIG. 8 illustrates a flowchart of an example method 800, according to some implementations. For clarity of presentation, the description that follows generally describes method 800 in the context of the other figures in this description. For example, method 800 can be performed by the user equipment 102 of FIG. 1. It will be understood that method 800 can be performed, for example, by any suitable system, environment, software, hardware, or a combination of systems, environments, software, and hardware, as appropriate. In some implementations, various steps of method 800 can be run in parallel, in combination, in loops, or in any order.

A user equipment, e.g., an eRedCap, determines a number of repetitions for a random access response or a paging message using downlink control information or an associated physical random access channel (802).

The user equipment receives one or more instances of the random access response or the paging message (804).

The user equipment decodes at least one of the one or more instances of the random access response or the paging message using the number of repetitions (806).

The order of steps in the method 800 described above is illustrative only, and the method 800 can be performed in different orders. For example, the user equipment can receive an instance of the RAR or the paging message and then determine the number of repetitions.

In some implementations, the method 800 can include additional steps, fewer steps, or some of the steps can be divided into multiple steps. For example, the method 800 can include one or more steps, or data, described with reference to FIG. 6 or 7.

In addition to reduced bandwidth operation, eRedCap UEs may also operate at reduced data rates compared to legacy UEs. In some instances, a base station may need to adjust peak data rates for eRedCap UEs accordingly to accommodate their maximum data rates, which may be lower than legacy UEs in certain situations. A supported maximum data rate for a user equipment can be calculated using V_{layer}, Qₘ, N_{PRB}^{BW}, Tₛ, and overhead (“OH”). V_{layer} is the maximum number of supported layers given by higher layer parameter maxNumberMIMO-LayersPDSCH for downlink and maximum of higher layer parameters maxNumberMIMO-LayersCB-PUSCH and maxNumberMIMO-LayersNonCB-PUSCH for uplink. Qₘ is the maximum supported modulation order given by higher layer parameter. N_{PRB}^{BW} is the maximum resource block allocation in bandwidth. Tₛ is the average OFDM symbol duration. OH is the overhead and takes the following values for FR1: 0.14 for FR1 downlink, and 0.08 for FR1 uplink. In some instances, a base station uses these parameters to determine the maximum data rate for a UE. As depicted in Table 6 below, the peak data rates (e.g., 17.7 Mbps/18.9 Mbps DL/UL data rate) as determined based on common values for certain use cases far exceed the target peak data rates of eRedCap UEs. For example, eRedCap UEs used as industrial wireless sensors may be restricted to less than 2 Mbps data rates, while video surveillance use cases may target a 2-4 Mbps data rate for economic video or 7.5-25 Mbps data rate for high-end video. In some use cases, eRedCap UEs may target a maximum of 10 Mbps data rate to improve cost savings.

TABLE 6
Achievable peak data rate

| | | | | | | OH | Approx. Data |
|---|---|---|---|---|---|---|---|
| SCS | BW | N_{PRB}^{BW} | ν_{layer} | Qₘ | Tₛ | (DL/UL) | Rate (DL/UL) |
| 30 kHz | 5 MHz | 11 | 1 | 6 | 3.57*10⁻⁰⁵ | 0.14/0.08 | 17.7 Mbps/18.9 |
| | | | | | | | Mbps |
| 30 kHz | 10 MHz | 24 | 1 | 6 | 3.57*10⁻⁰⁵ | 0.14/0.08 | 38.6 Mbps/41.2 |
| | | | | | | | Mbps |
| 30 kHz | 20 MHz | 51 | 1 | 6 | 3.57*10⁻⁰⁵ | 0.14/0.08 | 81.9 Mbps/87.6 |
| | | | | | | | Mbps |

To reduce the peak data rate used for communication with an eRedCap UE, a device, e.g., a base station or an eRedCap or another UE, can use a set of scaling factor values to compute the supported maximum data rate for downlink, uplink, or both. The device can apply the scaling factor S to achieve a supported maximum data rate R′ using R′=S*R where R is the maximum data rate computed based on the legacy approach (e.g., see Table 7, below). The device can determine the scaling factor S using any appropriate process. For instance, in some examples, the options used for the scaling factor S may be hard-encoded in a wireless communications specification, such as 3GPP standards. In an example, the scaling factor S options can include three different sets S∈(0.1, 0.2, 0.4, 1), S∈(0.1, 0.2, 0.8, 1), or S∈(0.1, 0.4, 0.8, 1), and various means may be used to coordinate between the base station and the UE which set to apply in certain instances. As the different scaling factor options may be defined in a standard, the base station or UE may only need to communicate an index to indicate which scaling factor to use in a particular instance. In some examples, an eRedCap UE can report the scaling factor S as part of a UE capability report.

As shown in Table 7, below, the maximum data rate for an eRedCap user equipment can be calculated using the scaling factor S, v_{layer}, Qₘ, N_{PRB}^{BW}, Tₛ, and overhead (“OH”), with the latter values as defined above. As depicted in Table 7 below, different types of eRedCaps can use different scaling factors given the respective maximum data rate R′ for the respective type. For instance, using a scaling factor of 0.1, eRedCap UEs used as industrial wireless sensors can have an approximate downlink rate of 1.77 Mbps and an approximate uplink rate of 1.89 Mbps, both of which are less than 2 Mbps. eRedCap UEs used for economic video can use a scaling factor of 0.2 for an approximate downlink rate of 3.54 Mbps and an approximate uplink rate of 3.78 Mbps, both of which are in the target maximum rate of 2-4 Mbps. Similarly, eRedCap UEs can use scaling factors of 0.4, 0.8, or 1, for high-end video to have an approximate downlink rate of 7.08 Mbps, 14.16 Mbps, or 17.7 Mbps and an approximate uplink rate of 7.56 Mbps, 15.12 Mbps, and 18.9 Mbps, respectively, all of which are around the 7.5-25 Mbps data rate for high-end video.

TABLE 7
Achievable peak data rate with scaling factor parameter

| | | | | | Scaling | Approx. Data | |
|---|---|---|---|---|---|---|---|
| SCS | BW | N_{PRB}^{BW} | ν_{layer} | Qₘ | Factor | Rate (DL/UL) | Use Cases |
| 30 kHz | 5 MHz | 11 | 1 | 6 | 0.1 | 1.77 Mbps/1.89 | Industrial |
| | | | | | | Mbps | wireless sensors |
| 30 kHz | 5 MHz | 11 | 1 | 6 | 0.2 | 3.54 Mbps/3.78 | Economic video |
| | | | | | | Mbps | |
| 30 kHz | 5 MHz | 11 | 1 | 6 | 0.4 | 7.08 Mbps/7.56 | Low-tiers of |
| | | | | | | Mbps | high-end video |
| 30 kHz | 5 MHz | 11 | 1 | 6 | 0.8 | 14.16 Mbps/15.12 | Mid-tiers of |
| | | | | | | Mbps | high-end video |
| 30 kHz | 5 MHz | 11 | 1 | 6 | 1 | 17.7 Mbps/18.9 | Top-tiers of |
| | | | | | | Mbps | high-end video |

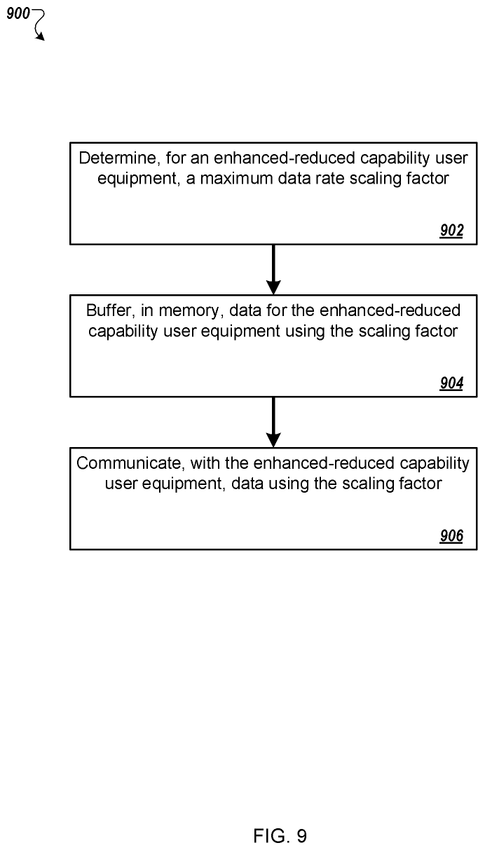

FIG. 9 illustrates a flowchart of an example method 900, according to some implementations. For clarity of presentation, the description that follows generally describes method 900 in the context of the other figures in this description. For example, method 900 can be performed by a device, e.g., the user equipment 102 or the base station 104 of FIG. 1. It will be understood that method 900 can be performed, for example, by any suitable system, environment, software, hardware, or a combination of systems, environments, software, and hardware, as appropriate. In some implementations, various steps of method 900 can be run in parallel, in combination, in loops, or in any order.

A device determines, for an enhanced-reduced capability user equipment, a maximum data rate scaling factor (902). The device can determine the scaling factor using any appropriate process described in this specification.

The device can buffer, in memory, data for the enhanced-reduced capability user equipment using the scaling factor (904). For instance, when the device is a base station, the device can buffer data for sending to a user equipment. When the device is a user equipment, e.g., an eRedCap, the device can buffer data for sending to a base station or another user equipment.

The device communicates, with the enhanced-reduced capability user equipment, data using the scaling factor (906). For instance, the communication can be sending data, receiving data, or a combination of both. When a base station communicates data it can send, across a downlink, data to a user equipment or receive, across an uplink, data from the user equipment. When a user equipment communicates data it can send, across an uplink or a sidelink, data to another device or receive, across an uplink or a sidelink, data from another device.

In some implementations, the method 900 can include additional steps, fewer steps, or some of the steps can be divided into multiple steps. For example, the method 900 can include steps 902 and 904. In some examples, the method 900 can include steps 902 and 906.

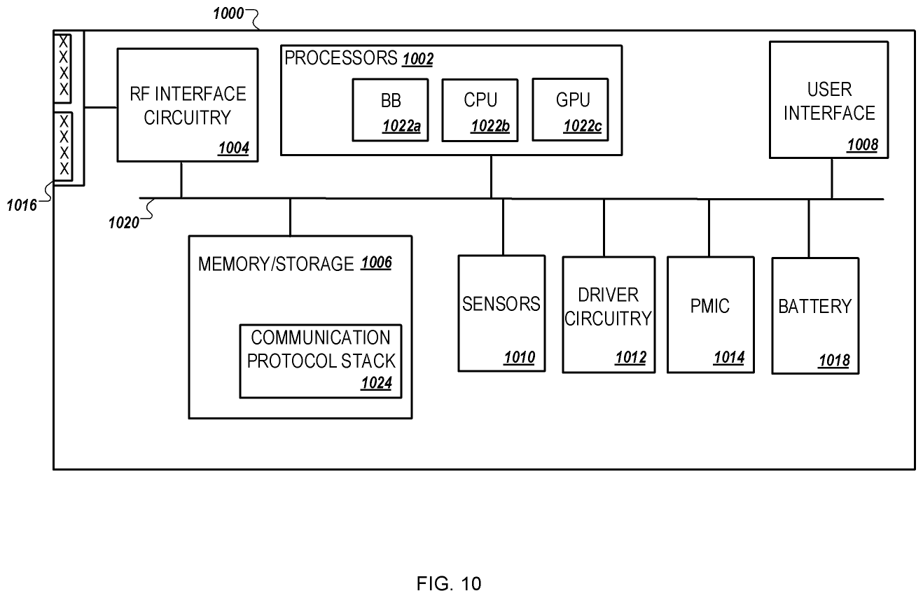

FIG. 10 illustrates a UE 1000, in accordance with some embodiments. The UE 1000 may be similar to and substantially interchangeable with UE 102 of FIG. 1.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, antenna structure 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some embodiments, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1004. The baseband processor circuitry 1022A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some embodiments, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1016.

In various embodiments, the RF interface circuitry 1004 may be configured to transmit/receive signals in a manner compatible with NR access technologies.

The antenna 1016 may include antenna elements to convert electrical signals into radio waves to travel through the air and to convert received radio waves into electrical signals. The antenna elements may be arranged into one or more antenna panels. The antenna 1016 may have antenna panels that are omnidirectional, directional, or a combination thereof to enable beamforming and multiple input, multiple output communications. The antenna 1016 may include microstrip antennas, printed antennas fabricated on the surface of one or more printed circuit boards, patch antennas, phased array antennas, etc. The antenna 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensor circuitry 1028 and control and allow access to sensor circuitry 1028, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some embodiments, the PMIC 1014 may control, or otherwise be part of, various power saving mechanisms of the UE 1000 including DRX as discussed herein. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

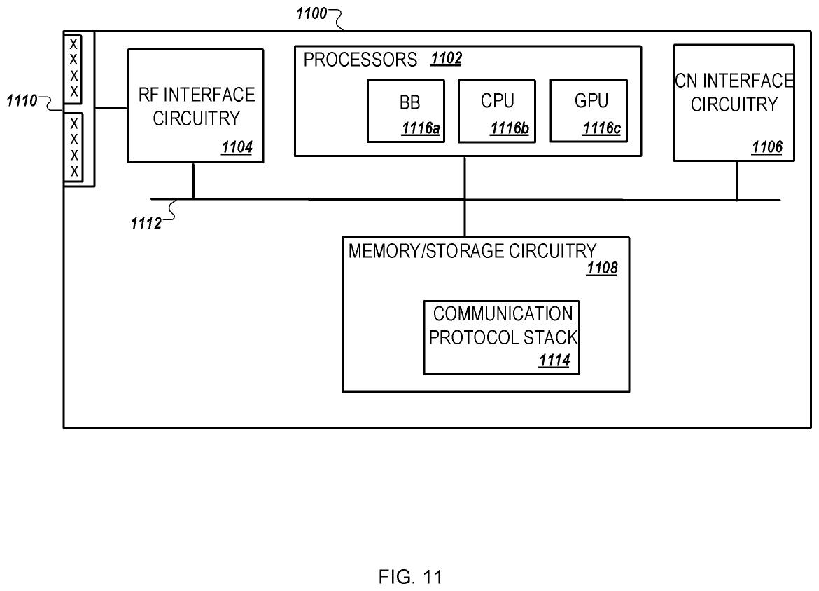

FIG. 11 illustrates an access node 1100 (e.g., a base station or gNB), in accordance with some embodiments. The access node 1100 may be similar to and substantially interchangeable with base station 104. The access node 1100 may include processors 1102, RF interface circuitry 1104, core network (CN) interface circuitry 1106, memory/storage circuitry 1108, and antenna structure 1110.

The components of the access node 1100 may be coupled with various other components over one or more interconnects 1112. The processors 1102, RF interface circuitry 1104, memory/storage circuitry 1108 (including communication protocol stack 1114), antenna structure 1110, and interconnects 1112 may be similar to like-named elements shown and described with respect to FIG. 10. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various embodiments, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 1100 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 1100; a MAC/PHY split wherein RRC, PDCP, RLC, and MAC layers are operated by the CRAN/vBBUP and the PHY layer is operated by the access node 1100; or a “lower PHY” split wherein RRC, PDCP, RLC, MAC layers and upper portions of the PHY layer are operated by the CRAN/vBBUP and lower portions of the PHY layer are operated by the access node 1100.

In V2X scenarios, the access node 1100 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 includes determining, by a user equipment, a type of a transmission; selecting, based on the type of the transmission, a bandwidth mode from a plurality of bandwidth modes; and communicating, using the bandwidth mode, the transmission.

Example 2 includes, wherein determining the type of the transmission comprises determining a radio resource control (“RRC”) connection state of the user equipment.

Example 3 includes, wherein determining the type of the transmission comprises determining whether to perform a synchronization signal block (“SSB”) based radio resource management (“RRM”) measurement or whether the user equipment is in an RRC_IDLE state or both.

Example 4 includes, wherein selecting the bandwidth mode comprises selecting, based on determining to perform the synchronization signal block (“SSB”) based radio resource management (“RRM”) measurement or that the user equipment is in the RRC_IDLE state or both, a first bandwidth mode from the plurality of bandwidth modes that has a larger frequency range than a second bandwidth mode from the plurality of bandwidth modes.

Example 5 includes, wherein communicating the transmission comprises receiving, using the first bandwidth mode, one or more of an entire set of synchronization signal block (“SSB”) signals, a control resource set (“CORESET”) 0, one or more random access messages, or an SSB-based radio resource management (“RRM”) measurement.

Example 6 includes, wherein selecting the bandwidth mode comprises selecting, based on determining to not perform the synchronization signal block (“SSB”) based radio resource management (“RRM”) measurement and that the user equipment is not in the RRC_IDLE state, a second bandwidth mode from the plurality of bandwidth modes that has a smaller frequency range than a first bandwidth mode from the plurality of bandwidth modes.

Example 7 includes, wherein selecting the bandwidth mode comprises selecting a bandwidth mode from the plurality of bandwidth modes including a first bandwidth mode and a second bandwidth mode.

Example 8 includes, wherein the first bandwidth mode is selected from a group comprising 10 MHz or 20 MHz.

Example 9 includes, wherein the second bandwidth mode is 5 MHz.

Example 10 includes determining, using one or more predetermined parameters, at least one of the plurality of bandwidth modes.

Example 11 includes, wherein determining the at least one of the plurality of bandwidth modes comprises determining the at least one of the plurality of bandwidth modes that is hardcoded.

Example 12 includes, wherein determining the at least one of the plurality of bandwidth modes comprises determining a bandwidth mode that supports at least one control resource set (“CORESET”) configuration that enables aggregation level 16 for common search space (“CSS”) sets with 30 kHz subcarrier spacing (“SCS”).

Example 13 includes, wherein selecting the bandwidth mode comprises selecting a bandwidth mode from the plurality of bandwidth modes including a first bandwidth mode and a second bandwidth mode that has a smaller frequency range than the first bandwidth mode.

Example 14 includes, wherein the first bandwidth mode covers a synchronization signal block (“SSB”) bandwidth of 7.2 MHz for 30 kHz subcarrier spacing (“SCS”).

Example 15 includes communicating, by a base station and using a first bandwidth mode, a first transmission with a user equipment; determining that a second transmission with the user equipment will use a second bandwidth mode that is a different bandwidth mode than the first bandwidth mode; determining a period of time for a switch from the first bandwidth mode to the second bandwidth mode; waiting the period of time after communicating the first transmission using the first bandwidth mode; and in response to waiting the period of time, transmitting, using the second bandwidth mode, the second transmission.

Example 16 includes, wherein one of the first transmission or the second transmission comprises a synchronization signal block (“SSB”).

Example 17 includes, wherein determining the period of time for the switch from the first bandwidth mode to the second bandwidth mode comprises: determining, by the base station, one or more properties of the user equipment; and determining, based on the one or more properties, the period of time for the switch from the first bandwidth mode to the second bandwidth mode.

Example 18 includes, wherein determining the one or more properties of the user equipment comprises determining, using a user equipment capability report, the one or more properties of the user equipment.

Example 19 includes, wherein determining the one or more properties of the user equipment comprises determining one or more hardcoded properties.

Example 20 includes, receiving, by a user equipment and in a half-slot, a synchronization signal/physical broadcast channel (“SSB”) block that comprises seven symbols spanning an entire half-slot; and synchronizing, with a base station, using the SSB block in the half-slot.

Example 21 includes, wherein receiving the SSB block comprises receiving, in the half-slot, a physical broadcast channel (“PBCH”) in a first symbol, a second symbol, a fourth symbol, a sixth symbol, and a seventh symbol.

Example 22 includes, wherein the PBCH comprises ten physical resource blocks (PRB) in frequency domain and five symbols in time domain.

Example 23 includes, wherein receiving the SSB block comprises receiving, in the half-slot, the SSB block that includes data other than PBCH in resource block 5 and resource block 6 in a first symbol and a second symbol, respectively.

Example 24 includes, wherein receiving the SSB block comprises receiving, in the half-slot, a primary synchronization signal in a third symbol.

Example 25 includes, wherein receiving the SSB block comprises receiving, in the half-slot, a secondary synchronization signal in a fifth symbol.

Example 26 includes, wherein transmitting the SSB block comprises transmitting, for each of the seven symbols in the half-slot, ten resource block for the respective symbol.

Example 27 includes, wherein receiving the SSB block comprises receiving, in the half-slot, the SSB block that includes a mapping of PBCH to resource elements in increasing order of a frequency subcarrier index within each time-domain symbol that carries PBCH.

Example 28 includes, wherein receiving the SSB block comprises receiving, in the half-slot, the SSB block that include a mapping of PBCH to resource elements in increasing order of a sub-block index, and then a frequency subcarrier index within each time-domain symbol that carries PBCH.

Example 29 includes, wherein receiving the SSB block comprises receiving, in the half-slot, a PBCH sub-block.

Example 30 includes, wherein the PBCH sub-block comprises: a sub-block resource index #0 that includes resource elements (“REs”) in a symbol index 0 in the half-slot and resource blocks (“RBs”) from RB #1 to RB #5 in frequency domain; a sub-block resource index #1 that includes REs in a symbol index 3 in the half-slot and RBs from RB #1 to RB #10 in frequency domain; a sub-block resource index #2 that includes REs in a symbol index 0 in the half-slot and RBs from RB #6 to RB #10 in frequency domain; a sub-block resource index #3 that includes REs in a symbol index 1 in the half-slot and RBs from RB #1 to RB #5 in frequency domain; a sub-block resource index #4 that includes REs in a symbol index 1 in the half-slot and RBs from RB #6 to RB #10 in frequency domain; a sub-block resource index #5 that includes REs in a symbol index 6 in the half-slot and RBs from RB #1 to RB #5 in frequency domain; a sub-block resource index #6 that includes REs in a symbol index 5 in the half-slot and RBs from RB #1 to RB #10 in frequency domain; and a sub-block resource index #7 that includes REs in a symbol index 6 in the half-slot and RBs from RB #6 to RB #10 in frequency domain.

Example 31 includes, wherein receiving the SSB block comprises receiving, in the half-slot and using frequency range 1, the SSB block.

Example 32 includes, wherein receiving the SSB block comprises receiving, in a slot and according to a slot-based time-domain pattern, the SSB block and at least one downlink control symbol, uplink control symbol, or guard period.

Example 33 includes, wherein receiving the SSB block comprises receiving, in the slot, one or more downlink control symbols followed by the SSB block.

Example 34 includes, wherein receiving the SSB block comprises receiving, in the slot, five downlink control symbols followed by the SSB block.

Example 35 includes, wherein receiving the SSB block comprises receiving, in the slot, the SSB block followed by one or more uplink control symbols, a guard period, or both.

Example 36 includes, wherein receiving the SSB block comprises receiving, in the slot, the SSB block followed by two symbols for one or more uplink control symbols, a guard period, or both.

Example 37 includes, wherein receiving the SSB block comprises receiving, in the slot, the SSB block in the sixth to twelfth symbols in the slot.

Example 38 includes, wherein receiving the SSB block comprises receiving, in the slot, the SSB block that include a mapping to resource elements in increasing order of a frequency subcarrier index within each time-domain symbol that carries PBCH.

Example 39 includes, wherein the slot comprises fourteen symbols.

Example 40 includes determining a number of repetitions for a random access response or a paging message using downlink control information; receiving one or more instances of the random access response or the paging message; and decoding at least one of the one or more instances of the random access response or the paging message using the number of repetitions.

Example 41 includes, wherein determining the number of repetitions comprises determining the number of repetitions using one or more bits in the downlink control information that explicitly identify the number of repetitions.

Example 42 includes, determining the number of repetitions comprises determining the number of repetitions using a scrambling bit sequence in Cyclic Redundancy Check (“CRC”) bits of the downlink control information that identifies the number of repetitions.

Example 43 includes, wherein a first scrambling bit sequence of “<0, 0, 0, 0, . . . , 0, 0>” indicates a number of repetitions of 1, a second scrambling bit sequence of “<0, 1, 0, 1, . . . , 0, 1>” indicates a number of repetitions of 2, a third scrambling bit sequence of “<1, 0, 1, 0, . . . , 1, 0>” indicates a number of repetitions of 3, and a fourth scrambling bit sequence of “<1, 1, 1, 1, . . . , 1, 1>” indicates a number of repetitions of 4.

Example 44 includes determining a number of repetitions for a random access response or a paging message using a number of repetitions for an associated physical random access channel communication; receiving one or more instances of the random access response or the paging message; and decoding at least one of the one or more instances of the random access response or the paging message using the number of repetitions.

Example 45 includes, wherein the associated physical random access channel communication comprises a most recent physical random access channel communication that is nearest in time with respect to the random access response or the paging message.

Example 46 includes determining, by a base station, whether a device to which the base station will send a random access response or a paging message is an enhanced reduced capability device; in response to determining that the device is an enhanced reduced capability device, determining a scaling factor for the enhanced reduced capability device; and sending, by the base station and to the device and using the scaling factor for the enhanced reduced capability device, the random access response or the paging message.

Example 47 includes, wherein the scaling factor for the enhanced reduced capability device comprises 0.125.

Example 48 includes determining, for an enhanced-reduced capability user equipment, a maximum data rate scaling factor; and communicating, with the enhanced-reduced capability user equipment, data using the maximum data rate scaling factor.

Example 49 includes, wherein determining the maximum data rate scaling factor comprises determining the maximum data rate scaling factor using a type of data that will be communicated with the enhanced-reduced capability user equipment.

Example 50 includes, wherein determining the maximum data rate scaling factor comprises dynamically determining the maximum data rate scaling factor using a maximum data rate for the enhanced-reduced capability user equipment.

Example 51 includes buffering, in memory, data for the enhanced-reduced capability user equipment using the maximum data rate scaling factor.

Example 52 includes, wherein communicating the data comprises communicating, to the enhanced-reduced capability user equipment, buffered data from the memory.

Example 53 includes, wherein communicating the data comprises sending, by a base station, the data to the enhanced-reduced capability user equipment.

Example 54 includes, wherein communicating the data comprises receiving, by a base station, the data from the enhanced-reduced capability user equipment.

Example 55 includes, wherein determining the maximum data rate scaling factor comprises determining the maximum data rate scaling factor selected from a group comprising 0.1, 0.2, 0.4, 0.8, or 1.

Example 56 includes, wherein determining the maximum data rate scaling factor comprises determining, by a base station, the maximum data rate scaling factor using a user equipment capability report.

Example 57 includes comprising determining the maximum data rate scaling factor comprises determining, by a base station, the maximum data rate scaling factor using a scaling factor index received from the enhanced-reduced capability user equipment.

Example 58 may include one or more non-transitory computer-readable media comprising instructions to cause an electronic device, upon execution of the instructions by one or more processors of the electronic device, to perform one or more elements of a method described in or related to any of examples 1-57, or any other method or process described herein.

Example 59 may include an apparatus comprising logic, modules, or circuitry to perform one or more elements of a method described in or related to any of examples 1-57, or any other method or process described herein.

Example 60 may include a method, technique, or process as described in or related to any of examples 1-57, or portions or parts thereof.

Example 61 may include an apparatus comprising: one or more processors and one or more computer-readable media comprising instructions that, when executed by the one or more processors, cause the one or more processors to perform the method, techniques, or process as described in or related to any of examples 1-57, or portions thereof.

Example 62 may include a signal as described in or related to any of examples 1-57, or portions or parts thereof.

Example 63 may include a datagram, information element, packet, frame, segment, PDU, or message as described in or related to any of examples 1-57, or portions or parts thereof, or otherwise described in the present disclosure.

Example 64 may include a signal encoded with data as described in or related to any of examples 1-57, or portions or parts thereof, or otherwise described in the present disclosure.

Example 65 may include a signal encoded with a datagram, IE, packet, frame, segment, PDU, or message as described in or related to any of examples 1-57, or portions or parts thereof, or otherwise described in the present disclosure.

Example 66 may include an electromagnetic signal carrying computer-readable instructions, wherein execution of the computer-readable instructions by one or more processors is to cause the one or more processors to perform the method, techniques, or process as described in or related to any of examples 1-57, or portions thereof.

Example 67 may include a computer program comprising instructions, wherein execution of the program by a processing element is to cause the processing element to carry out the method, techniques, or process as described in or related to any of examples 1-57, or portions thereof.

Example 68 may include a signal in a wireless network as shown and described herein.

Example 69 may include a method of communicating in a wireless network as shown and described herein.

Example 70 may include a system for providing wireless communication as shown and described herein.

Example 71 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-20. (canceled)

21. A method comprising:
determining, by a device for a user equipment, a type of a transmission;
selecting, based on the type of the transmission, a bandwidth mode from a plurality of bandwidth modes; and
communicating, using the bandwidth mode, the transmission.

22. The method of claim 21, wherein determining the type of the transmission comprises determining a radio resource control (“RRC”) connection state of the user equipment.

23. The method of claim 21, wherein determining the type of the transmission comprises determining whether to perform a synchronization signal block (“SSB”) based radio resource management (“RRM”) measurement or whether the user equipment is in an RRC_IDLE state or both.

24. The method of claim 21, wherein:
selecting the bandwidth mode comprises selecting a bandwidth mode from the plurality of bandwidth modes including a first bandwidth mode and a second bandwidth mode;
the first bandwidth mode is selected from a group comprising 10 MHz or 20 MHz; and
the second bandwidth mode is 5 MHz.

25. The method of claim 21, wherein selecting the bandwidth mode comprises selecting a bandwidth mode from the plurality of bandwidth modes including a first bandwidth mode and a second bandwidth mode that has a smaller frequency range than the first bandwidth mode.

26. A method comprising:
receiving, by a device for a user equipment and in a half-slot, a synchronization signal/physical broadcast channel (“SSB”) block that comprises seven symbols spanning an entire half-slot; and
synchronizing, with a base station, using the SSB block in the half-slot.

27. The method of claim 26, wherein receiving the SSB block comprises receiving, in the half-slot, a physical broadcast channel (“PBCH”) in a first symbol, a second symbol, a fourth symbol, a sixth symbol, and a seventh symbol.

28. The method of claim 27, wherein the PBCH comprises ten physical resource blocks (PRB) in frequency domain and five symbols in time domain.

29. The method of claim 27, wherein receiving the SSB block comprises receiving, in the half-slot, the SSB block that includes data other than PBCH in resource block 5 and resource block 6 in a first symbol and a second symbol, respectively.

30. The method of claim 26, wherein receiving the SSB block comprises receiving, in the half-slot, the SSB block that includes a mapping of PBCH to resource elements in increasing order of a frequency subcarrier index within each time-domain symbol that carries PBCH.

31. The method of claim 26, wherein receiving the SSB block comprises receiving, in the half-slot, the SSB block that include a mapping of PBCH to resource elements in increasing order of a sub-block index, and then a frequency subcarrier index within each time-domain symbol that carries PBCH.

32. The method of claim 26, wherein receiving the SSB block comprises receiving, in the half-slot, a PBCH sub-block.

33. The method of claim 32, wherein the PBCH sub-block comprises:
a sub-block resource index #0 that includes resource elements (“REs”) in a symbol index 0 in the half-slot and resource blocks (“RBs”) from RB #1 to RB #5 in frequency domain;
a sub-block resource index #1 that includes REs in a symbol index 3 in the half-slot and RBs from RB #1 to RB #10 in frequency domain;
a sub-block resource index #2 that includes REs in a symbol index 0 in the half-slot and RBs from RB #6 to RB #10 in frequency domain;
a sub-block resource index #3 that includes REs in a symbol index 1 in the half-slot and RBs from RB #1 to RB #5 in frequency domain;
a sub-block resource index #4 that includes REs in a symbol index 1 in the half-slot and RBs from RB #6 to RB #10 in frequency domain;
a sub-block resource index #5 that includes REs in a symbol index 6 in the half-slot and RBs from RB #1 to RB #5 in frequency domain;
a sub-block resource index #6 that includes REs in a symbol index 5 in the half-slot and RBs from RB #1 to RB #10 in frequency domain; and
a sub-block resource index #7 that includes REs in a symbol index 6 in the half-slot and RBs from RB #6 to RB #10 in frequency domain.

34. The method of claim 26, wherein receiving the SSB block comprises receiving, in a slot and according to a slot-based time-domain pattern, the SSB block and at least one downlink control symbol, uplink control symbol, or guard period.

35. A processor configured to, when executing instructions stored in a memory, perform operations comprising:
receiving, in a half-slot, a synchronization signal/physical broadcast channel (“SSB”) block that comprises seven symbols spanning an entire half-slot; and
synchronizing, with a base station, using the SSB block in the half-slot.

36. The processor of claim 35, wherein receiving the SSB block comprises receiving, in the half-slot, a physical broadcast channel (“PBCH”) in a first symbol, a second symbol, a fourth symbol, a sixth symbol, and a seventh symbol.

37. The processor of claim 36, wherein the PBCH comprises ten physical resource blocks (PRB) in frequency domain and five symbols in time domain.

38. The processor of claim 36, wherein receiving the SSB block comprises receiving, in the half-slot, the SSB block that includes data other than PBCH in resource block 5 and resource block 6 in a first symbol and a second symbol, respectively.

39. The processor of claim 35, wherein receiving the SSB block comprises receiving, in the half-slot, the SSB block that includes a mapping of PBCH to resource elements in increasing order of a frequency subcarrier index within each time-domain symbol that carries PBCH.

40. The processor of claim 35, wherein receiving the SSB block comprises receiving, in the half-slot, the SSB block that include a mapping of PBCH to resource elements in increasing order of a sub-block index, and then a frequency subcarrier index within each time-domain symbol that carries PBCH.
